(19) United States
(12) Patent Application Publication
(10) Pub. No.: US 2026/0310003 A1
(43) Pub. Date: Oct. 8, 2026

(54) LIGHTING ARRANGEMENT COMPRISING A LIGHT COLLIMATING OPTICAL ELEMENT AND ARRAY OF LIGHT EMITTING DIODES

(71) Applicant: SIGNIFY HOLDING B.V., EINDHOVEN (NL)

(72) Inventors: ERIK PAUL BOONEKAMP, BUNNIK (NL); LUDOVICUS JOHANNES LAMBERTUS HAENEN, SINT OEDENRODE (NL)

(21) Appl. No.: 19/482,270

(22) PCT Filed: Apr. 22, 2024
(86) PCT No.: PCT/EP2024/060867

§ 371 Date: Nov. 7, 2025

(30) Foreign Application Priority Data
May 8, 2023 (EP) 23171974.1

(51) Int. Cl. G02B 27/30; F21V 5/04; F21V 8/00; F21W 131/406; F21Y 115/10

(52) U.S. Cl. CPC G02B 27/30; F21V 5/041; G02B 6/0008; F21W 2131/406; F21Y 2115/10

(57) ABSTRACT

An optical system is provided. The optical system comprising a light collimating optical element, a housing and an array of light emitting diodes, LEDs. The housing is housing the light collimating optical element and having an inner light absorbing wall. The array of LEDs is configured to emit light into the light collimating optical element. The array of LEDs comprises a first set of LEDs consisting of one or more centrally arranged LEDs and a further set of LEDs consisting of an arrangement of LEDs arranged around the first set of LEDs. The array of LEDs is arranged at a first opening of the housing.

### FIELD OF THE INVENTION

The present invention generally relates to an optical system comprising a light collimating optical element and an array of light emitting diodes. More specifically, the present invention is related to an optical system comprising an array of light emitting diodes, a cylindrical housing and a light collimating optical element arranged to emit the light of LEDs.

### BACKGROUND OF THE INVENTION

Adaptable light effects become more and more interesting for consumer lighting applications. One of the most interesting applications is illumination with a color gradient source. Smooth color gradients on a wall, floor or table are potentially interesting in e.g., sleeping rooms and living rooms, and would be in demand both for consumer lighting applications and for use in retail lighting as a way of highlighting specific objects with a colorful gradient spot. As an example, aiming an illumination beam with a color gradient source at an object increases the attention for that object by making a large color contrast between central part of the beam and the edge of the beam.

However, both retail and especially consumer lighting applications require low cost and flexible optical components for them to be a viable option in everyday use, regardless of their additional lighting features. In addition of it being a cost efficient lighting solution with additional illumination features, such as an luminaire capable of creating a color gradient, it is also of importance that the luminaire is capable of functioning as a “normal” illumination device. As such, a desired feature would be that the color gradient can be switched ON or OFF such that a luminaire capable of being a color gradient spot can also be used as a normal single-color LED spot. It would also be desirable that this feature would not be exclusive to just a spotlight, but also light bulbs, luminaires and other consumer lighting products in general.

Hence, it is of interest to overcome at least some of the deficiencies of the current optical systems according to present technologies, and to provide an optical system arrangement comprising the feature of creating a color gradient, while still being able to function as a regular illumination device as well.

EP3650746A1 discloses a light-emitting device including an optical member including first and second light emitting elements, first and second light condenser portions, and a light guide portion.

US20220243875A1 discloses a light emitting device projecting a beam onto a target surface and comprising at least one light engine comprising a light source, a light mixing chamber and an optical component.

WO2018149796A2 relates to a luminaire and to a method for controlling the emission characteristic of this luminaire.

### SUMMARY OF THE INVENTION

This and other objects are achieved by providing a light generation system having the features in the appended claims.

Hence, according to a first aspect of the present invention, there is provided an optical system. The optical system comprising a light collimating optical element, a housing, housing the light collimating optical element and having an inner light absorbing wall. The optical system further comprises an array of light emitting diodes, LEDs, configured to emit light into the light collimating optical element, wherein the array of LEDs comprises a first set of LEDs consisting of one or more centrally arranged LEDs and a further set of LEDs consisting of an arrangement of LEDs, which may be arranged around the first set of LEDs, and wherein the array of LEDs may be arranged at a first opening of the housing. The light collimating optical element comprises a first light guide, a further light guide, and a lens downstream of the light guides. The lens has a focal plane/surface and further has a light receiving surface spaced from the first and further light guide by a distance Dll in the range of 10-200 μm. The first light guide is configured to guide first light of a first color as emitted from the first set of LEDs to (and into) the lens and the further light guide is configured to guide further light of a further color as emitted from the further set of LEDs to (and into) the lens, the further color being different from the first color. The first light guide and the further light guide have mutual different positions with respect to the lens, such that, in operation, the first light and the further light are redirected by the lens to mutually different but partly overlapping respective portions of a target area to be illuminated by the optical system and thus to provide a color gradient beam. Each light guide has a respective output face which is remote from the focal plane/surface of the lens by a spacing distance Sd, wherein 0.1 mm<=Sd<=10 mm. The output faces of the light guides can be arranged in between the lens and the focal plane/surface of the lens (in other words, the light guides protrude through the focal plane/surface or the focal plane/surface is located inside the light guides), the focal plane/surface can be positioned in between the lens and the output faces of the light guides, or the focal plane/surface can be located inside the lens. The location of the focal plane/surface is dependent from the index of refraction of the lens material, the higher the index of refraction, the shorter the focal distance of the lens (assuming a constant radius of a spherical respectively circular cylindrical lens).

The lens typically may be a spherical lens or a circular cylindrical lens. In case of the lens being a cylindrical lens, the light receiving surface is not one of the end faces of the cylinder, but is a part of the curved cylinder wall. In case the lens is a spherical lens, the lens is a full sphere (and not a hemisphere).

In a cross-sectional view through the lens, the first light guide and the further light guide a respective thickness (Tlg1, Tlg2 . . . ) of the first and further light guide is in the range of 5%-25% of a thickness (Tlens) at a location where the light from the LEDs is coupled into the lens, i., e. at the location of the light receiving surface.

Furthermore, the spacing distance Sd may be a fixed distance rendering the optical system of being a relatively simple and cheap construction, as (complex) mechanical means to mutually move/shift the lens with respect to the light guides can be omitted.

Thus, the present invention is based on the idea of providing two different sets of LEDs, with different placement and individual formation. The light from the LEDs is then configured to emit their light into the light collimating optical element such that the light from the two different sets of LEDs may present versatile shaped light beams. For example, the optical system may provide a central beam having a first set of light properties surrounded by a halo of light having a second set of light properties. This by configuring the two different sets of LEDs, to have different light features. Features as different color, brightness or color temperature makes the optical system very versatile in terms of what kind illumination that can be displayed by the optical system.

The optical system, using the collimating optical element facilitate so that the light coming from the optical system is pointing straight forward, and the light coming from the two different sets of LED is substantially not mixed when leaving the light collimating optical element.

The optical system may have the feature that an optical separator is provided between the first and further light guide such that cross-over between the first and further light guide is counteracted so that the first light and the further light enter the lens essentially mutually unmixed. The optical separator may be at least one of i) an air slit/gap, ii) a plurality of spacers, iii) a specular reflective coating, iv) a rippled outer surface of the light guide, v) a specular reflective wall/plate, and vi) a layer having a lower index of refraction than an index of refraction of the first and further light guide.

The optical system may further comprise a diffusor arranged at and/or downstream of the output faces of the light guides. Such a diffusor could be arranged at a second opening of the housing. The second opening of the housing is preferably opposite to the first opening of the housing. The diffusor facilitates creation of a softer light and makes the transition between the edge of the light coming from the first set of LEDs and the further set of LEDs smoother. Yet, the optical system can be free from a diffuser, rendering the optical system relatively simple and cheap.

The first set of LEDs may be configured to emit white light and the further set of LEDs may be configured to emit colored light. This facilitates for the optical system to create the effect of a color gradient. Using a diffuser in connection with combination white light emitting first set of LEDs and colored light emitting further set of LEDs facilitates creation of a smooth transition between the white light and colored light. Hence a less noticeable smooth gradient between the white and colored light may be achieved.

The housing may be configured to absorb emission angles of ≥70 degrees with regards to the optical axis. Hence, the housing may be set to remove additional light emission that otherwise would interfere with the light collimating optical element.

The light collimating optical element may comprise a free-form lens. The free-form lens may be configured to convert a Lambertian source into a Gaussian shaped intensity distribution. Especially, the free-form lens may be configured to convert a Lambertian source into a Gaussian shaped intensity distribution having a full width half maximum, FWHM, of ≤10 degrees. Such free-form lens facilitates provision of a smooth color transition onto the object that is highlighted by the optical system.

The light collimating optical element may comprise a first light guide, a further light guide, and a spherical lens. The first light guide may be configured to guide light emitted from the first set of LEDs to the spherical lens. The further light guide may be configured to guide light emitted from the further set of LEDs to the spherical lens.

The different light guides is typically assigned to separate sets of LEDs. As such, the light emitted by the first set of LEDs may be separated from the light emitted by the further set of LEDs and the result being that two adjacent illuminations occur. Hence, if the color of light emitted from the different sets of LEDs the final illuminated beam result in a strong angle dependent color separation.

The lens may be arranged at a distance of 10-200 μm from the first and further light guides. Such distance prohibit optical contact between the lens and the light guides.

An end portion of the first and further light guides may be complementary to the (curved) light receiving surface of the lens.

This allows for a close fit between the light guides and the spherical lens, yet without mutual optical contact. Hence, optical aberration between the light guide and the spherical lens may be prohibited.

If the lens is a spherical lens, the first light guide may be rod shaped. The further light guide may be cylindrical. The first light guide may be arranged inside the further light guide. A gap of 10-200 μm may be formed between the first and further light guides.

The light collimating optical element may further comprise a holder configured to support the further light guide. The holder may be cylindrical. An inner surface of the holder may be exhibiting a root mean square, RMS, roughness greater than 10 μm, preferably in the range of 10-500 μm. Such a surface roughness of the holder prohibits movement of the further light guide inside the holder. As such, there is no need for additional adhesive for fixating the further light guide to the holder.

If the lens is a cylindrical lens the first and further light guide(s) may be arranged in a stacked configuration having stacking direction perpendicular to a length axis of the cylindrical lens, and wherein a gap of 10-200 μm is formed between the/adjacent first and further light guide(s).

The array of LEDs may be mounted on a printed circuit board, PCB. Such a PCB allows for a wide selection of physical configuration of array of LEDs. In addition of being a physical support for the LEDs the PCB may act as a heat transfer. The PCB may also have the capability of absorbing light reflected from the components of the optical system. Hence, unwanted reflected light that might otherwise interfere with the optical system may be absorbed by the PCB.

The optical system may further comprise a light absorbing layer covering the PCB.

According to a second aspect of the present invention, there is provided a spotlight luminaire comprising the optical system according to the first aspect.

The spotlight luminaire may further comprise a control circuit configured to independently control the first and further sets of LEDs.

Hence, the LEDs of the optical system may be independently controlled. As such color, brightness and intensity of the first and further sets of LEDs may be individually selected.

The above mentioned features of the first aspect, when applicable, apply to this second aspect as well. In order to avoid undue repetition, reference is made to the above.

Further objectives of, features of, and advantages with, the present invention will become apparent when studying the following detailed disclosure, the drawings and the appended claims. Those skilled in the art will realize that different features of the present invention can be combined to create embodiments other than those described in the following.

Hence, it is to be understood that this inventive concept is not limited to the particular steps of the methods described or component parts of the systems described as such method and system may vary. It is also to be understood that the terminology used herein is for purpose of describing particular embodiments only and is not intended to be limiting. It must be noted that, as used in the specification and the appended claim, the articles “a”, “an”, “the”, and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings do not exclude other elements or steps

### BRIEF DESCRIPTION OF THE DRAWINGS

This and other aspects of the present invention will now be described in more detail, with reference to the appended drawings showing embodiment(s) of the invention.

FIG. 1 is a cross sectional view of an example of an optical system according to the present invention.

FIG. 2 is an example of a light collimating optical element of an optical system according to the present invention.

FIG. 3 is an exploded view of the set of light guides of the light collimating optical element illustrated in FIG. 2.

FIG. 4 is an exploded view of another example of an optical system according to the present invention.

FIG. 5 illustrates a PCB with two different sets of LEDs.

FIG. 6 is a schematic perspective view of another example of an optical system according to the invention that illuminates a target area.

FIG. 7 is an schematic illustration of a spotlight luminaire comprising an optical system according to the present invention.

### DETAILED DESCRIPTION

The present inventive concept will now be described more fully hereinafter with reference to the accompanying drawings, in which currently preferred variants of the inventive concept are shown. This inventive concept may, however, be implemented in many different forms and should not be construed as limited to the variants set forth herein; rather, these variants are provided for thoroughness and completeness, and fully convey the scope of the present inventive concept to the skilled person. The drawings are not necessarily to scale, some features may be shown on an enlarged scale for the sake of explanation.

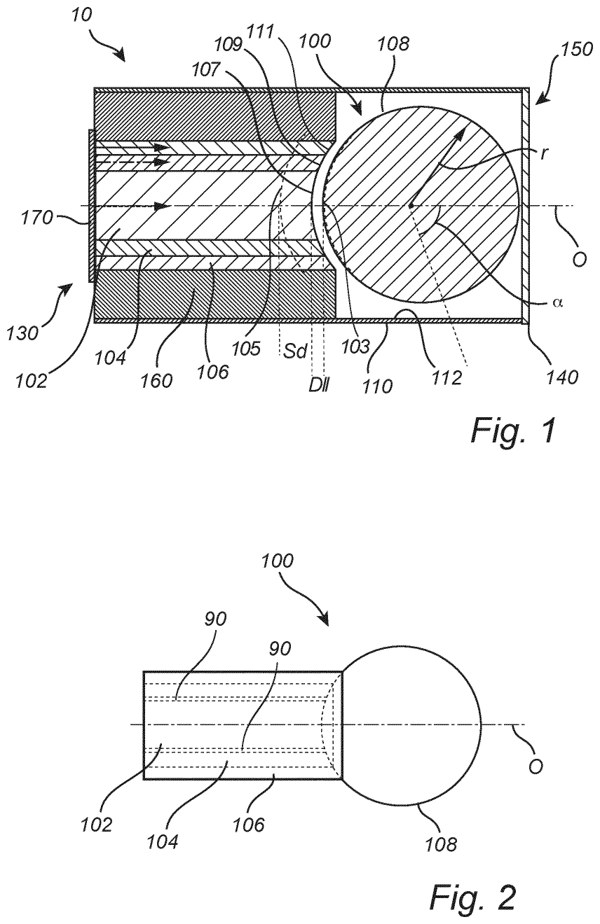

In the following, an optical system 10 will be described in connection with FIGS. 1-5. The optical system 10 may form part of a luminaire, e.g. in the form of a spotlight luminaire. The optical system 10 comprises a light collimating optical element 100, a housing 110 and an array of light emitting diodes, LEDs, 120.

The housing 110 is housing the light collimating optical element 100. The housing 110 may be cylindrical. The housing 110 having an inner light absorbing wall 112. The cylindrical housing 110 may be manufactured of a non-reflective, usually black, material as a way to capture stray and/or other undesired light within the cylindrical housing 110. The housing 110 may also be configured to capture undesired light, as product of Total Internal Reflection, TIR, or light leakage, which may come from the light collimating optical element 100 as TIR-light or light leakage from transition areas within the optical system 10. Further, the housing 110 may be configured to absorb emission angles of ≥70 degrees with regards to an optical axis O of the light collimating optical element 100. Hence, the housing 110 may be set to remove additional light emission that otherwise would interfere with the light collimating optical element 100.

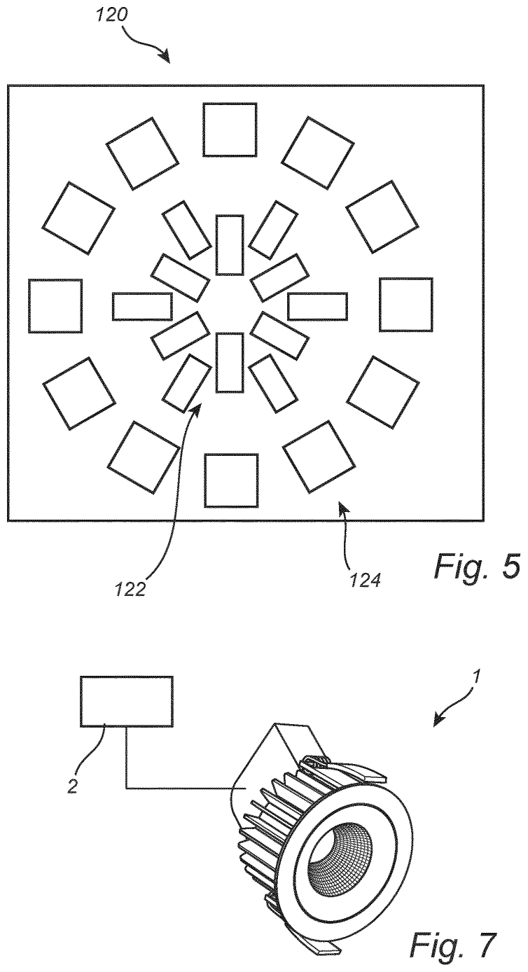

The LEDs 120 are configured to emit light into the light collimating optical element 100. The array of LEDs 120 comprises a first set of LEDs 122 consisting of one or more centrally arranged LEDs and a further set of LEDs 124 consisting of an arrangement of LEDs arranged around the first set of LEDs 122. The arrangement may be ring-shaped. The array of LEDs 120 is arranged at a first opening 130 of the housing 110. The array of LEDs 120 may comprise even more further sets of LEDs. For example, a still further set of LEDs may be arranged as an arrangement of LEDs outside the further set of LEDs 124. Each such still further arrangement of LEDs may be ring-shaped. In FIG. 4 an example is illustrated where two such still further arrangements of LEDs are present in the array of LED:s 120.

Different LEDs in the array of LEDs 120 may emit light having different properties in e.g. intensity and/or colors. For example, the first set of LEDs 122 may be configured to emit white light or colored light and the further set of LEDs 124 may be configured to emit white light or colored light, yet of a different color or white than emitted by the first set of LEDs. This facilitates for the optical system 10 to create the effect of a color gradient. White light in this circumstance may be defined as having a color temperature between 2200K-6500K. It may also be defined as a predetermined color scheme such as warm white, WW, cold white, CW, or a mixture of CW and WW. The further set of LEDs 124 may comprise either single color LEDs, such as blue LEDs, or other saturated colors such as blue, red, green or cyan LEDs. The further set of LEDs 124 may also comprise tunable RGB LEDs having the possibility of displaying all colors needed. It is however noted that the first set of LEDs is not limited to white light. The first set of LEDs may be configured to emit light of a first color, color temperature, CT, or correlated color temperature, CCT, and the further set of LEDs may be configured to emit light of a second color, CT or CCT different from the first color, CT, or CCT.

The array of LEDs 120 may be mounted on a printed circuit board, PCB 170. An example of an array of LEDs 120 mounted on a PCB 170 is illustrated in FIG. 5. In this example, the array of LEDs 120 comprises a first set of LEDs 122 consisting of a plurality of centrally arranged LEDs and a further set of LEDs 124 consisting of an arrangement of a plurality pf LEDs arranged around the first set of LEDs 122. A PCB 170 allows for a wide selection of physical configuration of the array of LEDs 120. In addition of being a physical support for the LEDs 120, the PCB 170 may act as a heat transfer. The PCB 170 may also have the capability of absorbing light reflected from the components of the optical system 10. Hence, unwanted reflected light may be absorbed by the PCB 170. In order to increase the light absorbing properties at the first opening of the housing 110 a light absorbing layer may be arranged to cover the PCB 170. The material of the light absorbing layer may be of a non-reflective, usually black, material as a way to capture stray and/or other undesired light coming from reflection of the optical system 10.

As illustrated in connection with FIGS. 1-3, the light collimating optical element 100 may comprise a plurality of light guides 102, 104, 106 and a spherical lens 108. The material of the light guides 102, 104, 106 may be selected from poly(methyl methacrylate), PMMA, polycarbonate, PC, or glass. The material of the spherical lens 108 may be selected from PMMA, PC, or glass. In the example illustrated in FIGS. 1-3 the light collimating optical element 100 comprises a first light guide 102, a further light guide 104 and a still further light guide 106. The first light guide 102 is configured to guide and output via a respective output face 107 light emitted from the first set of LEDs 122 into the lens 108 via a light receiving surface 103 of the spherical lens 108. The further light guide 104 is configured to guide and output via a respective output face 109 light emitted from the further set of LEDs 124 into the spherical lens 108 via the light receiving surface 103 of the spherical lens 108. The still further light guide 106 is configured to guide and output via a respective output face 111 light emitted from a still further set of LEDs into the spherical lens 108 via the light receiving surface 103 of the spherical lens 108. The spherical lens 108 has a (curved) focal surface 105 that is located inside the light guides 102, 104, 106 and is spaced by a spacing distance Sd from the respective output faces 107, 109, 111 of the respective first, further and still further light guides 102, 104, 106. The different light paths are illustrated with arrows in FIG. 1. Hence, each light guide is typically assigned to a separate set of LEDs. As such, the light emitted by the first set of LEDs 122 is separated from the light emitted by the further set of LEDs 124 and the result being that two adjacent illuminations occur. Hence, if the color of light emitted from the different sets of LEDs the final illuminated beam result in a strong angle dependent color separation.

In an ideal configuration, the light guide output faces 107,109,111 follow the shape of the spherical lens 108, such that any optical aberration that may occur when the light transfer from the light guide to the spherical lens is kept to a minimum. Hence, an end portion of the different light guides 102, 104, 106 is preferably complementary to the spherical lens 108. This allows for a close fit between the light guides 102, 104, 106 and the spherical lens 108. Further, the spherical lens 108 may be arranged at a distance Dll of 10-200 μm from the light guides 102, 104, 106. Such distance prohibit optical contact between the spherical lens 108 and the light guides 102,104, 106. The gap distance between the lightguides and the spherical lens may be accomplished using spacers (not shown). Hence, each light guide transport light from each set of LEDs to a position as close as possible to the spherical lens 106.

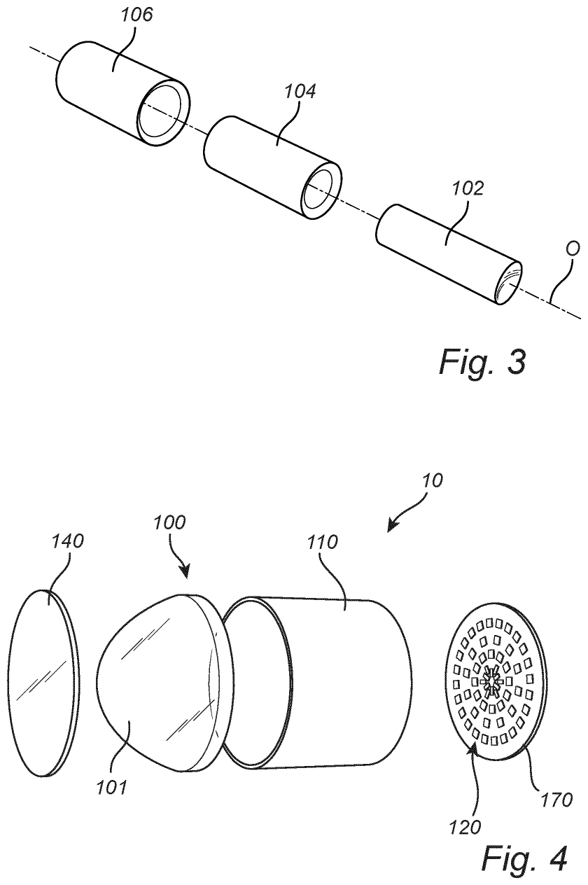

As illustrated in greater detail in FIG. 3 the first light 102 guide, the light guide being configured to guide light from the first set of LEDs 122 being centrally arranged, is preferably rod shaped. The further light 104 guide, the light guide being configured to guide light from the further set of LEDs 124 is preferably a cylinder. Any further light guide is also preferably a cylinder. The first light guide 102 is configured to be arranged inside the further light guide 104. A gap 90 of 10-200 μm is preferably formed between the first and further light guides 102, 104, see FIG. 2. The gap between the light guides may be accomplished using spacers (not shown). Alternative, or in combination, the gap can be introduced by making protrusions in an inside surface of a cylindrical light guide and/or an outside surface of the rod shaped light guide or an outside surface of a cylindrical light guide. Such protrusions will introduce a gap between the light guides. The protrusions may also prohibit movement a light guide arranged inside another light guide. As such, there is no need for additional adhesive for fixating a light guide to another light guide. Further, the gap between the light guides counteract undesired mixing by cross-over of light from one light guide into another light guide, this since optical contact between the light guides is prohibited by the gaps.

A holder 160 is preferably configured to support the outer most light guide. The holder 160 may be cylindrical. An inner surface of the holder 160 may be exhibit a root mean square, RMS, roughness greater than 10 μm, preferably in the range of 10-500 μm. Such a surface roughness of the holder 160 prohibits movement of the light guides inside the holder 160. As such, there is no need for additional adhesive for fixating the light guides to the holder 160.

In a specific example, light injected into each light guide 102, 104, 106 is collimated by the spherical lens 108 and allows illumination of a desired area. In order for this example to work, the cross sectional area of the light guides 102, 104, 106 may be much smaller than the cross section area of the spherical lens 108. The degree of the beam shaping of the optical system 10 is determined by the area of the light guide connected to the spherical lens 108 and a radius r of the spherical lens 108. A typical radius of the spherical lens 108 is 10-50 mm. A typical diameter of the first rod shaped light guide 102 is 2-20 mm. A typical wall thickness of a cylinder shaped light guide 104, 106 is 2-10 mm.

Alternatively to a light collimating optical element 100 comprising a plurality of light guides and a spherical or circular cylindrical lens, the optical system 10 may comprise a light collimating optical element 100 comprising a free-form lens 101. Such an optical system 10 is illustrated in connection with FIG. 4 as an exploded view of the optical system 10. The free-form lens 101 is preferably a solid lens. The free-form lens 101 is configured to convert a Lambertian source into a Gaussian shaped intensity distribution. Especially, the free-form lens 101 may be configured to convert a Lambertian source into a Gaussian shaped intensity distribution having a full width half maximum, FWHM, of ≤10 degrees. Such free-form lens 101 facilitates provision of a smooth color transition onto the object that is highlighted by the optical system 10. The material of the free-form lens 101 may be PMMA, PC, or glass. The free-form lens 101 may have a wide arrange of geometrical shapes, depending on the desired effect of the free-form lens 101.

The optical system 10, may further comprise a diffusor 140 arranged at a second opening 150 of the housing 110. The second opening 150 of the housing 110 is opposite to the first opening 130 of the housing 110. The diffusor 140 facilitates creation of a softer light and makes the transition between a boarder of the light coming from the first set of LEDs 122 and the further set of LEDs 124 smoother. The diffuser 140 may be a Gaussian diffusor converting a parallel beam of light into Gaussian shaped intensity distribution. Alternatively, the diffuser 140 may be a top hat diffuser, which produces a rectangular distribution. The desired distribution of the diffuser 140 may be chosen or manufactured according to a desired degree of full width at half maximum, FWHM, of the optical system 10. The material of the diffuser may be for PMMA, PC, glass etc. Using the diffuser 140 in connection with a combination of a white light emitting first set of LEDs 122 and a colored light emitting further set of LEDs 124 facilitates creation of a smooth transition between the white light and colored light.

In summary, the present invention is based on the idea of providing at least two different sets of LEDs 122, 124, with different placement and individual formation. The LEDs is then configured to emit their light into the light collimating optical element 100 such that the light from the at least two different sets of LEDs 122, 124 are kept substantially unmixed. Hence, versatile shaped light beams may be produced by the present optical system 10. For example, the optical system 10 may provide a central beam having a first set of light properties surrounded by a halo of light having a second set of light properties. This by configuring two different sets of LEDs 122, 124 to have different light properties. Properties as different color, brightness or color temperature makes the optical system 10 very versatile in terms of what kind illumination that can be displayed by the optical system 10. The optical system 10, using the collimating optical element 100 facilitate so that the light coming from the optical system 10 is pointing straight forward along an optical axis O of the collimating optical element 100, and the light coming from the different sets of LEDs 122 124 is substantially not mixed when leaving the light collimating optical element 100.

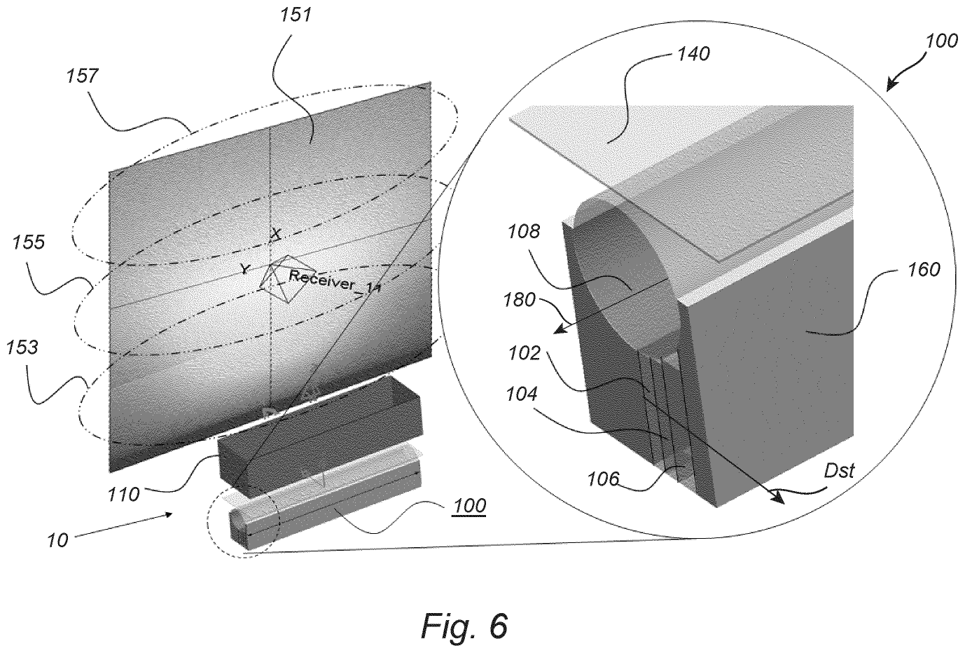

FIG. 6 shows a schematic perspective view of another example of an optical system 10 according to the invention that illuminates a target area 151. The optical system comprises an elongated housing 110 configured to accommodate an elongated optical element 100. The optical element comprises a holder 160 that holds a cylindrical lens 108 and a stack of plate shaped light guides 102, 104, 106 stacked in a stack direction Dst. Said stack direction Dst is perpendicular to a length axis 180 of the cylindrical lens 108. A diffuser 140 is arranged downstream of the lens 108. Each plate shaped light guide 102, 104, 106 is associated with one respective set of LEDs (not shown in FIG. 6). The first light guide 102 guides first light of a first color as emitted from the first set of LEDs to and into the lens, said first light subsequently is redirected by the cylindrical lens 108 to a respective first portion 153 of a target area 151 to be illuminated by the optical system 10. The further light guide 104 guides further light of a further color as emitted from the further set of LEDs to and into the lens, said further light subsequently is redirected by the cylindrical lens 108 to a respective further portion 155 of said target area 151. The still further light guide 106 guides further light of a further color as emitted from the still further set of LEDs to and into the lens, said still further light subsequently is redirected by the cylindrical lens 108 to a respective still further portion 157 of said target area 151. As shown, the first portion 153 overlaps partially with the further portion 155 there in the target area 151, and also that in the target area 151 the further portion 155 overlaps partially with the still further portion 157. The first color, the further color and the still further color comprise at least two different colors. Thus a smooth color gradient is obtained in the illuminated target area 151.

FIG. 7 schematically illustrates a spotlight luminaire 1 comprising an optical system 10 as discussed above at the hand of FIGS. 1-5. The spotlight luminaire 1 may further comprise a control circuit 2 configured to independently control the different sets of LEDs, e.g. the first and further sets of LEDs 122, 124 in the array of LEDs 120 in the optical system 10. Hence, the sets of LEDs 122, 124 of the optical system 10 may be independently controlled. As such, color, brightness and intensity of the different sets of LEDs 122, 124 may be individually selected and controlled. By controlling the set of LEDs of the optical system 10 independently it is e.g. possible to switch on/off the first and further sets of LEDs independently such that the spotlight luminaire 1 can be used both as a standard spotlight luminaire and a color gradient spotlight luminaire.

The person skilled in the art realizes that the present invention by no means is limited to the preferred examples described above. On the contrary, many modifications and variations are possible within the scope of the appended claims.

For example, additional light guides and/or sets of LEDs may be added to the optical system 10, in order to create additional illuminations adjacent to the already existing illuminations of the optical system 10.

Additionally, variations can be understood and effected by the skilled person in practicing the claimed invention, from a study of the drawings, the disclosure, and the appended claims.

1. An optical system comprising:
a light collimating optical element;
a housing, accommodating the light collimating optical element and having an inner light absorbing wall; and
an array of light emitting diodes, LEDs, configured to emit light into the light collimating optical element, wherein the array of LEDs comprises a first set of LEDs configured to emit first light of a first color first and a further set of LEDs configured to emit further light of a further color different from the first color,
wherein the light collimating optical element comprises a first light guide, a further light guide, and a lens downstream of the light guides, the lens having a focal plane/surface and having a light receiving surface spaced from the first and further light guide by a distance Dll in the range of 10-200 μm,
wherein the first light guide is configured to guide first light emitted from the first set of LEDs to the lens and the further light guide is configured to guide further light emitted from the further set of LEDs to the lens,
wherein the first light guide and the further light guide have mutual different positions with respect to the lens such that, in operation, the first light and the further light are redirected by the lens to different but mutually partly overlapping respective portions of a target area to be illuminated by the optical system and thus to provide a color gradient beam, and
wherein the light guides each have a respective output face which is remote from the focal plane/surface of the lens by a spacing distance Sd, wherein 0.1 mm<=Sd<=10 mm, the lens being one of a spherical lens and a circular cylindrical lens, wherein
when the lens is a spherical lens, the first light guide is rod shaped and the further light guide is cylindrical, wherein the first light guide is arranged inside the further light guide, and
when the lens is a cylindrical lens, the first and further light guide(s) are arranged in a stacked configuration having stacking direction Dst perpendicular to a length axis of the cylindrical lens,
wherein cross-over between the first and further light guide is counteracted in that an optical separator is provided between the first and further light guide such that the first light and the further light enter the lens essentially mutually unmixed, and
wherein the optical separator is at least one of i) an air slit/gap, ii) a plurality of spacers, iii) a specular reflective coating, iv) a rippled outer surface of the light guide, and v) a layer having a lower index of refraction than an index of refraction of the first and further light guide.

2. The optical system according to claim 1, wherein the output faces of the light guides are arranged in between the lens and the focal plane/surface of the lens.

3. The optical system according to claim 1, wherein the focal plane/surface of the lens is located inside the lens.

4. The optical system according to claim 1, wherein the focal plane/surface of the lens is located inside the light guides.

5. The optical system according to claim 1, wherein the air slit/gap is a gap of 10-200 μm between the first and the adjacent further light guides.

6. The optical system according to claim 1, further comprising a diffusor arranged at and/or downstream of the output faces of the light guides.

7. The optical system according to claim 1, wherein the first set of LEDs is configured to emit white light and the further set of LEDs is configured to emit colored light.

8. The optical system according to claim 1, wherein the housing is configured to absorb emission angles of α≥70 degrees with regards to the optical axis.

9. The optical system according to claim 1, wherein an end portion of the first and further light guides is complementary to the light receiving surface of the lens.

10. (canceled)

11. The optical system according to claim 1, wherein the light collimating optical element further comprises a holder configured to support the further light guide, wherein an inner surface of the holder is exhibiting a root mean square, RMS, roughness greater than 10 μm.

12. (canceled)

13. The optical system according to claim 1, wherein the array of LEDs are mounted on a printed circuit board, PCB, wherein the PCB is configured to absorb light reflected from components of the optical system.

14. A spotlight luminaire comprising an optical system according to claim 1.

15. The spotlight luminaire according to claim 14, further comprising a control circuit configured to independently control one or more of the first and each further set of LEDs.
